(19) United States
(12) Patent Application Publication
(10) Pub. No.: US 2015/0350761 A1
(43) Pub. Date: Dec. 3, 2015

(54) Mount for earphones

(71) Applicant: Birgit Heim, Frankfurt am Main (DE)

(72) Inventor: Birgit Heim, Frankfurt am Main (DE)

(21) Appl. No.: 14/726,185

(22) Filed: May 29, 2015

(30) Foreign Application Priority Data
May 30, 2014 (DE) 10 2014 107 676.1

(51) Int. Cl. H04R 1/10; H04R 31/00

(52) U.S. Cl. CPC H04R 1/105; H04R 31/00

(57) ABSTRACT

The invention relates to a mount (2) for earphones (4) and in particular a mount (2) adapted individually to the anatomical conditions of a user. In order to provide a considerably improved hold of the earphone (4) in the ear of the user, considerably improved comfort as well as considerably improved sound quality of the earphone (4) during use, the mount for earphones according to the invention comprises at least one fit film, wherein the fit film (3) comprises a holding section (15) for the earphone (4) and is designed for attachment to the auricle (1) of the user.

### BACKGROUND

The present invention relates to a mount for earphones and in particular to so-called “earbud earphones” and “in-ear earphones,” which are inserted into the ear or respectively the auricle of the user.

For quite some time, a plurality of head—and earphones has been offered for personal use. Corresponding head—or respectively earphones are used in the professional field and also in the private field, for example for listening to music or audio books.

Compact designs of head- or respectively earphones are particularly popular for private use since they permit mobile use, for example with an MP3 player or smartphone. In this connection, “in-ear earphones” and “earbud earphones” in particular are currently used, wherein in-ear earphones are designed for intra-aural use on or in the ear canal, while earbud earphones are clamped in the auricle of the user.

In the case of in-ear earphones, the attachment often takes place by means of rubber, silicone or foam parts in the upper ear canal. Additional earpieces are provided in some commercially available models, which grip around the auricle and should thus ensure additional protection from the earphones slipping out.

One problem in the earphones described above is that, due to the different sizes and shapes of the ears and in particular the auricle of individual users, they are insufficiently held or respectively are not very comfortable to wear. It was attempted in commercially available earbud earphones to solve this problem by providing a plastic or respectively rubber ring, which allows a certain adaptation for the auricle. However, this measure was successful only to a limited extent. In particular during the use of the earphones during athletic activities with correspondingly associated movement and, if applicable, vibrations, the hold of hitherto existing earphones is insufficient.

### SUMMARY

Thus, one object is to improve the hold and the comfort of earphones and in particular earbud and in-ear earphones during use.

The above object is solved by the mount for earphones according to the invention and the method according to the invention for producing a mount for earphones according to the independent claims. The dependent claims describe embodiments of the invention.

A main aspect of the present invention relates to an attachment of an earphone and in particular a so-called “earbud earphone” or respectively a so-called “in-ear earphone” to the auricle of a user by means of a film made of plastic material. The film can hereby be adapted e.g. individually to the ear or respectively the auricle of the user in order to provide a particularly good attachment of the earphone in the ear of the user.

In addition to a considerably improved hold of the earphone in the ear of the user, even during movement or vibrations during use, the mount according to the invention enables considerably improved comfort as well as considerably improved sound quality. The improved sound quality during audio playback is achieved in particular through the possibility of an optimized positioning of the earphones in the ear of the user. At the same time, the relatively light-weight film is hardly noticeable during the use of the earphones.

Furthermore, the mount according to the present invention permits a cost-effective, individual adaptation of the mount to the ear or respectively the auricle of the respective wearer or user, as will be explained in detail below, wherein it is simultaneously advantageously enabled to use commercially available earphone systems. Correspondingly, a user can use the respectively preferred earphone model without paying attention to whether it is suitable for the anatomy of his/her ear or respectively his/her auricle or respectively whether it is “compatible” with it.

Within the context of the present invention, the term “earphones” is understood to mean an encapsulated loudspeaker or respectively sound converter, which is worn in the auricle (earbud earphones) or in the upper ear canal (in-ear earphones). The earphone can hereby be wired or wireless.

The mount for earphones according to the invention comprises at least one fit film, wherein the fit film is designed for attachment to the auricle of a user and comprises at least one holding section for the earphone.

The fit film can hereby have all suitable designs, in order to engage at least partially with the auricle, or respectively in particular with the “anatomical structure” of the auricle such that the fit film is secured or respectively locked against slipping out.

In connection with the present invention, the terms “anatomical structure” or respectively “structure” of the auricle mean in particular the helix, crus helicis, scapha, antihelix, fossa triangularis, concha, cymba, cavum, tragus and/or antitragus.

The mount according to the invention comprises, as initially mentioned, a holding section for the earphone. The holding section can hereby have all suitable designs in order to securely attach the respective earphone to the fit film and in the operating position to the auricle of the user. The holding section may comprise in particular one or more attachment means like clips, clamps, notches or openings for the attachment of the earphone.

The fit film and the holding section can may designed as one piece or multiple pieces. Certainly, the mount or respectively fit film may have further components or sections. For example, a cable guide or respectively strain relief for the connection cable of the earphone may be provided on the mount.

According to one exemplary embodiment, the holding section comprises an opening, which is designed to receive the earphone. Such a design permits a particularly good attachment of the earphone in the mount.

The opening can may formed e.g. through punching, drilling or milling. The opening may be designed closed in the plane of the fit film or open on one side. The latter may be provided through arrangement of the opening in an edge area of the film. Advantageously, the diameter of the opening should be adapted to the outer diameter of a corresponding attachment section of the earphone in order to achieve a good attachment through clamping or respectively press fit. In addition, the edge of the opening may be designed angled in order to provide an even more improved mounting of the earphone in the opening.

In an additional or alternative exemplary embodiment, the fit film may be designed to engage with the crus helicis, the cymba, the tragus and/or the antitragus of the auricle during use, i.e. in the operating position of the mount in the auricle. Such a design provides a particularly good attachment of the mount to the auricle in that it engages with corresponding, anatomically given “undercuts” of the auricle.

An additional or alternative embodiment of the fit film may be advantageous to provide further improved sound quality such that a substantially closed volume exists in the operating position between the earphone and the eardrum or respectively between the front side of the membrane of the earphone sound converter and the eardrum.

Such a design may be provided for example in that the fit film is designed to rest at least in an edge area of the film on the auricle. It should be apparent that a completely pressure-tight connection between the auricle and fit film is not required even if the fit film should lie entirely on the auricle. For example, the fit film may be designed such that it covers the concha of the auricle of the user, if applicable with cymba and cavum, or respectively engages with the concha at its edge.

The fit film may be made for example of a plastic, wherein the flexibility of the fit film can be adapted through corresponding selection of material and thickness. According to an alternative or additional exemplary embodiment, the fit film may be designed as a plastic film with a thickness of between 0.5 to 3.0 mm, particularly preferably between 0.6 and 1.2 mm and in particular of 1.0 mm. Advantageously, the provided fit film may be designed alternatively or additionally with a substantially even thickness (+−0.2 mm) in order to provide an even elasticity.

According to an alternative or additional exemplary embodiment, the fit film may be made at least partially of polypropylene, polyethylene, polystyrene, ethylene vinyl acetate, polymethyl methacrylate, polyethylene terephthalate copolyester, cellulose propionate, thermoplastic polyurethane, thermoplastic elastomer or a combination of the aforementioned materials. The material can be selected for example based on the desired flexibility of the mount or respectively the shape and the weight of the earphone. When employing commercially available earphones, polyethylene terephthalate copolyester and ethyl vinyl acetate have proven to be particularly valuable materials for the fit film.

For the individual adaptation of the mount for the auricle of the respective user, the fit film may be produced by means of an impression of the auricle of the user. The impression may be made for example with a plaster and/or silicone cast of the auricle. The fit film may be formed in an impression method. The fit film may be shaped for example through heating and subsequent thermoforming.

A second aspect of the present invention relates to a method for producing an individually adaptable mount for earphones. Besides improved comfort, the present aspect of the invention provides an even further improved hold as well as an improved resting in the edge area of the mount on the auricle.

In the manufacturing method according to the present aspect of the invention, a cast of the auricle of a user is formed and at least one fit film is formed for attachment to the auricle of the user in an impression method using the cast. Additionally, at least one holding section for the earphone is formed in the fit film in order to obtain a mount for the earphone.

The holding section may comprise one or more attachment means, such as clips, clamps, notches or openings, in order to attach the earphone securely to the holding section.

The cast may be taken for example by means of plaster, latex, alginate, polyether and/or silicone material in the known manner, wherein the present method enables the use of cost-effective plaster since only one cast of the auricle but not of the ear canal is needed.

The at least one fit film may be formed in any suitable impression or respectively deformation method, such as e.g. a cast method, in particular injection molding, blow molding or thermoforming, wherein the latter is also called “deep-drawing” or “deep-draw method.”

Material and thickness of the fit film may be selected as previously explained with respect to the first aspect of the invention.

The fit film may be formed or respectively shaped directly on the cast but also via one or more intermediate steps. For example, it is conceivable in one exemplary embodiment to mold a second cast based on the first cast in order to obtain a positive cast. The same or a different casting material may be used. The impression of the fit film may in this case be conducted on the second cast in order to obtain in turn a negative cast.

According to an alternative or additional exemplary embodiment, the fit film may be printed by means of a 3D printer. For example, a digital “cast” may be formed manually but may also be obtained by scanning the cast.

According to a further alternative or additional exemplary embodiment, a cast film is molded on the cast of the auricle. The fit film may be molded correspondingly on the cast film.

The present embodiment enables a simple and cost-effective impression of the fit film as a negative cast of the auricle of the user via the cast film, designed correspondingly as a positive cast. The cast film and fit film may be formed in one of the impression or respectively deformation methods discussed above, wherein the same or different impression methods can be used for the production of the cast film and the fit film. Both the cast film and the fit film may be formed in a thermoforming method.

The cast film may generally be made of the material selected for the fit film. According to an exemplary embodiment, the cast film and fit film are designed such that they have differing elasticities. The present design is helpful in particular during the molding of the fit film in order to avoid an excess and, if applicable, permanent stretching of the fit film during separation of the molded fit film.

The setting of the elasticity can generally take place through the corresponding selection of the material and/or the thickness of the corresponding film. If for example polyethylene terephthalate copolyester is used for the fit film, which is relatively hard, the cast film may be made of a softer ethyl vinyl acetate in order obtain a differing elasticity. Certainly, the opposite material selection is also possible if the fit film of the mount needs to be designed more softly.

In an additional or alternative exemplary embodiment, liquid plastic material is inserted into the mold before the impression and in an intermediate step. This is helpful in particular for particularly undercut areas of the auricle of the respective user in order to achieve a particularly exact impression.

The incorporation of additional material may be beneficial in particular in areas, in which, e.g. through undercuts in the auricle, the fit film could be too thin, uneven or too unstable. The additional material can be incorporated for example by means of a known hotmelt gun, wherein the additional material is preferably made of the same plastic material as the fit film. In the subsequent deep-draw process, this material fuses correspondingly with the film.

According to an additional or alternative exemplary embodiment, the at least one holding section is formed by an opening in the fit film. Such a design permits a particularly good attachment of the earphone in the mount. With respect to the details, it is in this connection referred to the initially described first aspect of the invention.

The diameter of the opening may be adapted to the outer diameter of a corresponding attachment section of the earphone in order to achieve a good attachment through clamping. In addition, the edge of the opening can be designed angled in order to provide an even more improved mounting of the earphone in the opening. The opening may be inserted into the fit film through punching, drilling or milling, wherein punching is preferred due to the accuracy as well as the low time and cost expenditure.

It readily follows that applications are conceivable in which a cast of an auricle of the user is formed and a mount adapted correspondingly to this auricle is produced for an ear phone. However, in the same manner, sets of two mounts are also conceivable, wherein a first mount is adapted to the left auricle of the respective user and a second mount for the right auricle of the respective user. In this case, one cast per auricle is taken in order to obtain correspondingly two fit films and mounts adapted individually to the respective auricle.

The invention is explained below using exemplary embodiments.

### BRIEF DESCRIPTION OF THE DRAWINGS

It is shown in:

FIG. 1 a sectional view of an auricle of a user with ear canal,

FIG. 2 a first method step of an exemplary embodiment of the manufacturing method according to the invention for a mount for earphones in a perspective view,

FIGS. 3a and 3b a second method step of the exemplary embodiment of FIG. 2 in a schematic sectional view,

FIGS. 4a and 4b a third method step of the exemplary embodiment of FIG. 2 in a schematic sectional view,

FIG. 5a a perspective view of an exemplary embodiment of the mount according to the invention together with an exemplary earphone,

FIG. 5b a further perspective view of an exemplary embodiment according to FIG. 5a in the operating position,

FIG. 6 a first method step of an alternative exemplary embodiment for preparing an auricle cast in a perspective view,

FIG. 7 a second method step of the exemplary embodiment according to FIG. 6,

FIG. 8 a third method step of the exemplary embodiment according to FIG. 6, and

FIG. 9 a perspective, partial view of an auricle cast obtained according to the exemplary embodiment of FIGS. 6 to 8.

### DETAILED DESCRIPTION OF PREFERRED EMBODIMENTS

The figures show exemplary embodiments of the mount 2 for earphones 4 according to the invention and in particular for so-called “in-ear earphones,” which are inserted into the auricle 1 of a user. The figures further show exemplary embodiments of associated manufacturing methods according to the invention for mounts 2 for earphones 4.

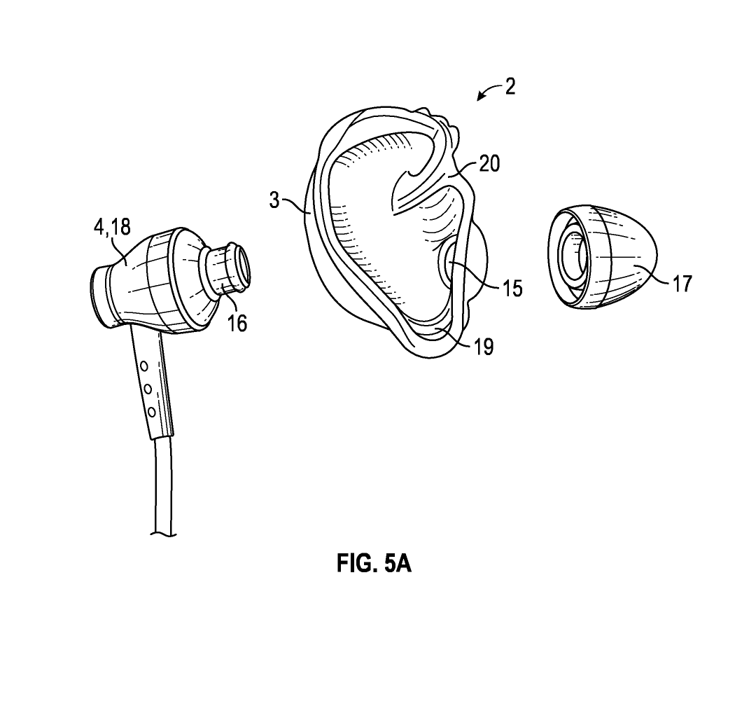

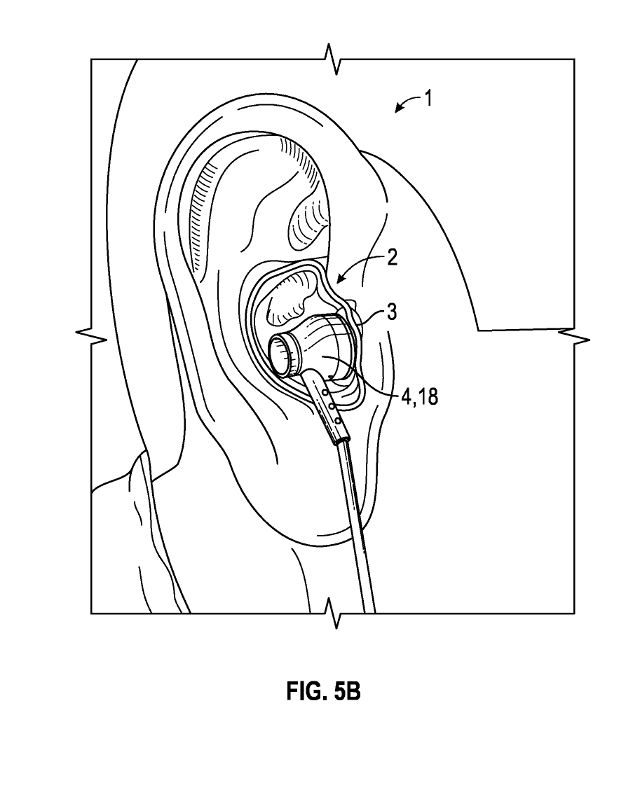

FIG. 5a shows a perspective view of an exemplary embodiment of the mount 2 for earphones 4 according to the invention. The mount 2 according to the present exemplary embodiment comprises a fit film 3, which is adapted to the contours or respectively the structure of the auricle 1 of a user, as explained in greater detail below.

The fit film 3 comprises a holding section 15 for attaching the earphone 4. As can be seen in FIG. 5a, the holding section 15 comprises an opening, wherein the diameter of the opening is adapted to the diameter of an attachment section 16 of the earphone 4 such that a force fit of the earphone 4 is given in the mount 2.

In order to connect the earphone 4 shown as an example in FIG. 5a with the mount 2, the plastic cover 17 of the earphone 4 is first separated from the earphone housing 18. The attachment section 16 of the earphone 4 is then guided through the opening of the holding section 15 and then in turn connected with the plastic covering 17 so that the mount 2 between earphone housing 18 and cover 17 is securely attached. The plastic cover 17 hereby provides a certain sound insulation so that the earphone 4 provides an optimal sound in the auricle 1 of the user.

If the ear phone 4 is attached to the mount 2, the entire arrangement can be inserted into the auricle 1 of the user. FIG. 5b shows the mount 2 with earphone 4 correspondingly inserted into the auricle 1 in the operating position according to the present exemplary embodiment.

As shown, the fit film 3 of the mount 2 covers the concha of the auricle 1 of the user, whereby a substantially closed volume between the sound converter of the earphone 4 and the eardrum of the user is given.

Furthermore, a first locking section 19 (see FIG. Sa) of the fit film 3 according to the present exemplary embodiment engages with the tragus and the antitragus of the auricle 1 such that the fit film 3 is correspondingly locked in the auricle 1. In the same manner, a second locking section 20 (see FIG. Sa) engages with the crus helicis as well as the cymba of the auricle 1. Correspondingly, an advantageously secure hold of the earphone 4 in the auricle 1 is given, even in the case of an athletic activity of the user.

In the present example, the film 3 consists of polyethylene terephthalate copolyester and has a substantially even thickness of 1 mm+−0.5 mm. At this thickness, the film 3 has the necessary flexibility for proper insertion into the auricle 1 and simultaneously a sufficient stability for receiving the in-ear earphone 4.

The mount 2 according to the present exemplary embodiment is adapted to the auricle 1 of the user in that it is produced by means of an impression of the auricle 1. According to the present example, the mount 2 is produced in a thermoforming method by means of an auricle cast of the user. The mount 2 is thus individually adapted to the anatomical properties of the auricle 1 of the respective user.

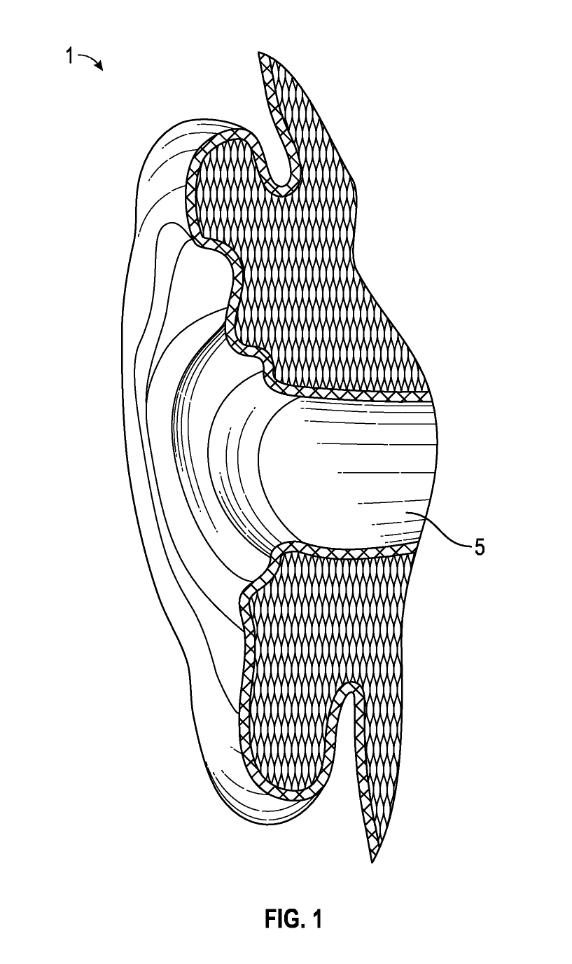

An exemplary production method for the initially discussed earphone mount 2 is explained below with respect to FIGS. 1-4.

A starting point of the method is a cast of the auricle 1 of the user. A schematic partial sectional view of a human auricle 1 with ear canal 5 is shown in FIG. 1.

The cast can be made for example by an otologist or a hearing aid acoustician. In contrast to casts which are required for the production of hearing aid ear molds, the present method does not require the impression of the ear canal 5. In contrast, as much of the surface of the auricle 1 as possible should be shaped in the cast.

The cast can be made with any suitable casting material, for example latex, alginate, polyether and/or silicone material. However, the production method according to the invention also permits the use of plaster as the casting material, which is considerably more cost-effective than the use of plastics.

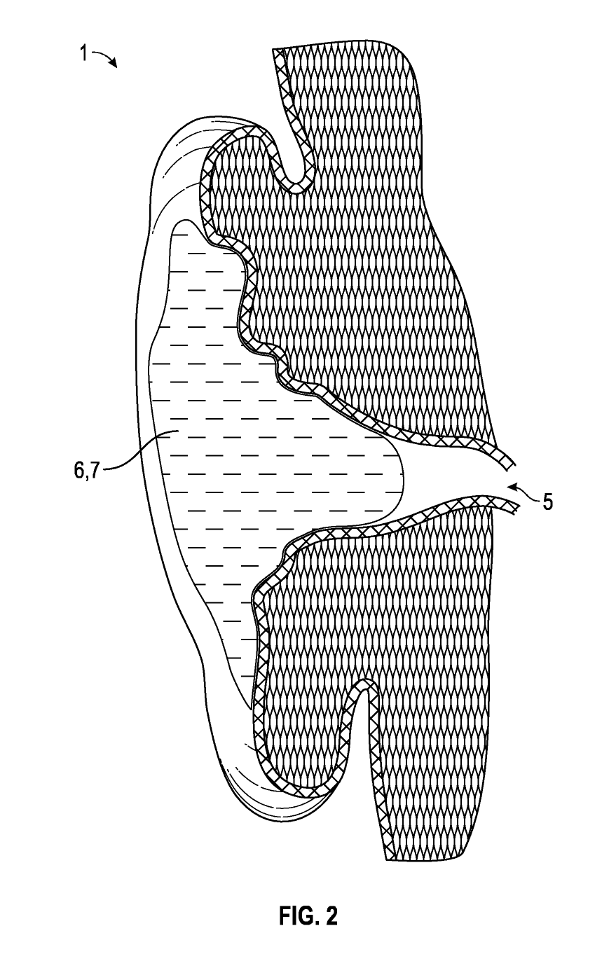

In order to create the cast, a cotton tamponade (not shown) is first inserted into the ear canal 5 after cleaning the ear canal 5 so that approximately 5 mm of the ear canal 5 are still free. Then both the tamponade as well as the auricle 1 are lubricated with food-grade oil or Vaseline. The respective casting material 6 is then added to the auricle 1 and hardened there, as shown in FIG. 2.

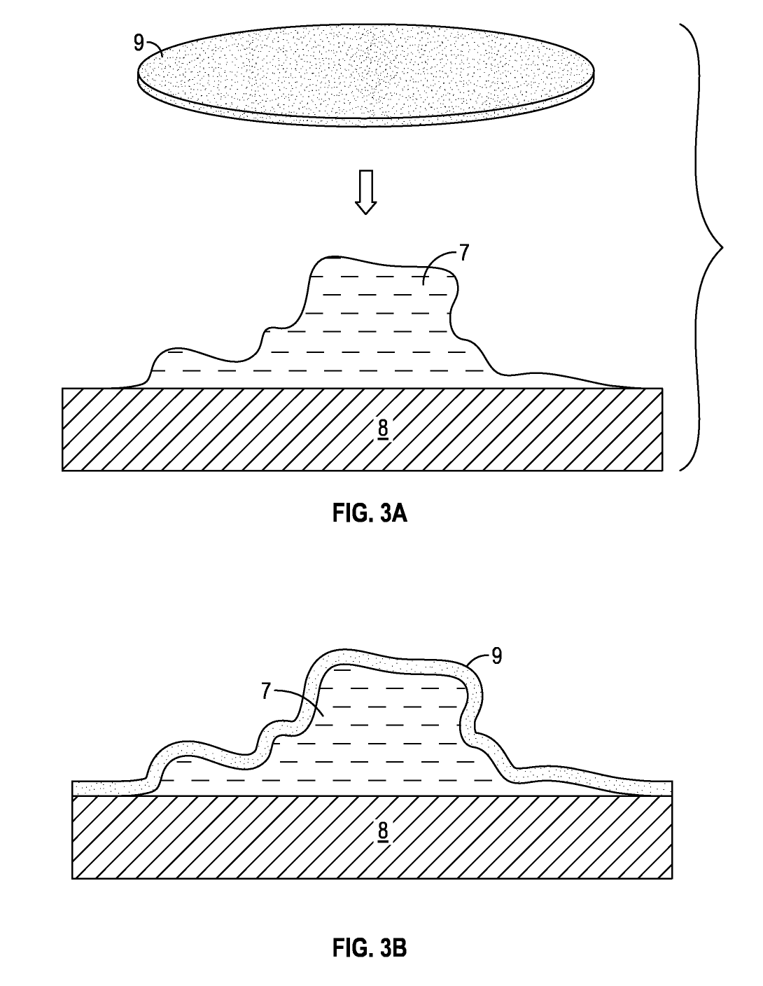

The correspondingly obtained and hardened cast 7 is carefully removed from the auricle 1 of the user and then applied to a deep-draw or respectively thermoforming device 8 as shown schematically in FIGS. 3a and 3b. The deep-draw device 8 corresponds with a commercially available deep-draw device from dental technology as is used for example for the production of mouth guards for athletes.

According to FIG. 3, a first cast film 9 made of ethyl vinyl acetate is heated and then put or respectively molded over the cast 7 by means of the deep-draw device 8 and a corresponding negative pressure. FIG. 3a hereby shows the cast film 9 before the molding on the cast 7, while FIG. 3b shows the correspondingly finished molded cast film 9, which forms correspondingly the surface contours of the cast 7.

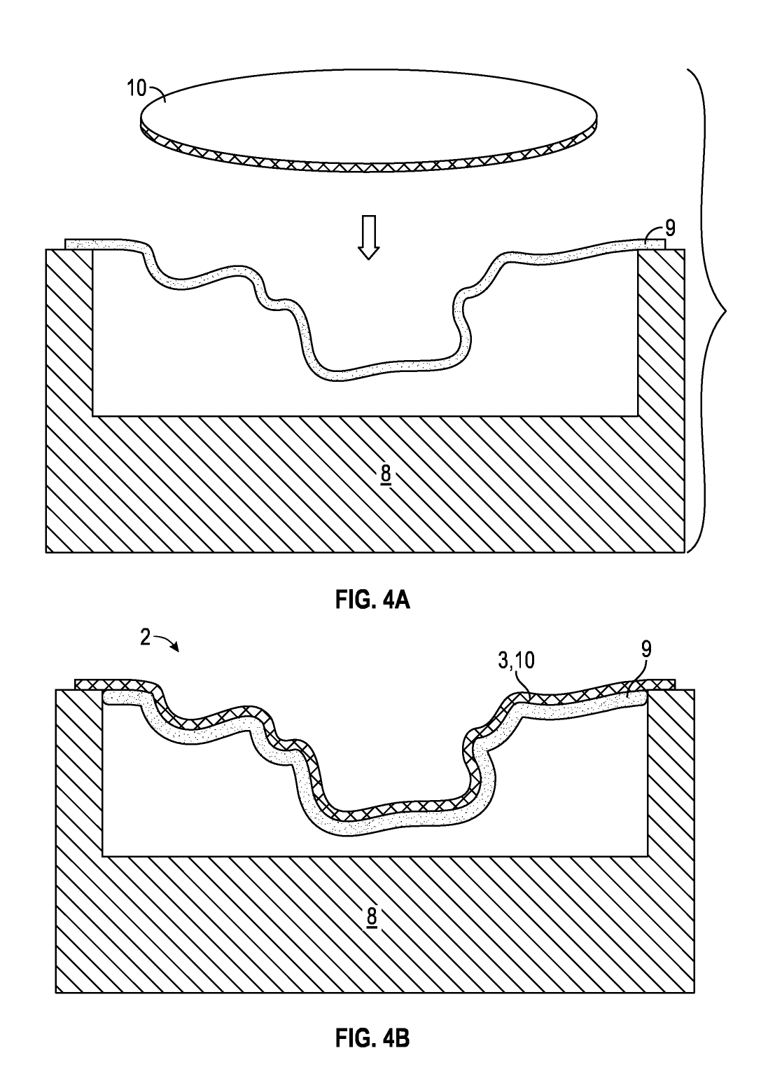

After the cooling of the film 9 and the removing of the cast 7, a positive cast of the auricle 1 is available. As can be seen in FIGS. 4a and 4b, a second cast film 10, which forms the later fit film 3, is molded with this positive cast in a further deep-draw process by means of the deep-draw device 8.

Due to the undercut areas of the auricle 1, these two deep-drawn films 9, 3 can only be separated from each other again without damage, if at least one of the two films 9, 3 is flexible in the shaped state. If both films 9, 3 are made of inflexible plastic, the films 9, 3 are then inseparably interlocked.

After the impression of the second cast film 10 is completed and it has been separated from the first cast film 9, the final size of the fit film 3 can be optionally adapted and the edges trimmed with commercially available tools (not shown).

As initially discussed, in order to complete the mount 2 shown in FIG. 5a at the point of the ear canal 5, an opening is punched (not shown) so that the sound channel of the earphone 4 just fits inside.

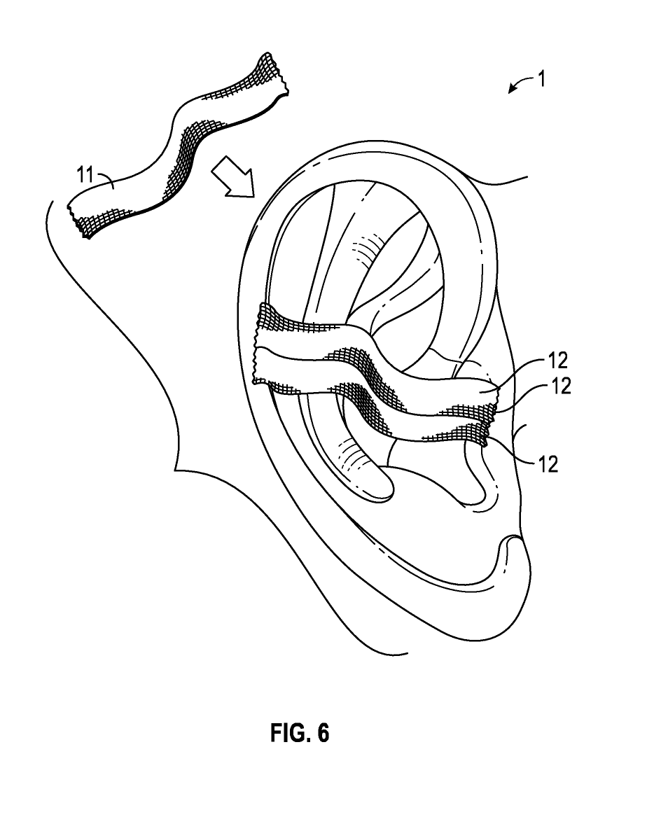

FIGS. 6-9 show an alternative exemplary embodiment of a production method for an auricle cast in schematic, perspective views, which is particularly suitable for use in the previously described production method for the mount 2. Correspondingly, the present exemplary embodiment can be used alternatively in the method step previously described with respect to FIG. 2.

As can be seen in particular in FIG. 6, a plaster bandage 11, as is used to create plaster splints, is cut into approx. 1.5-cm-wide strips 12 according to the present exemplary embodiment. These strips 12 are dipped briefly in water and carefully placed piece-by-piece on the auricle 1.

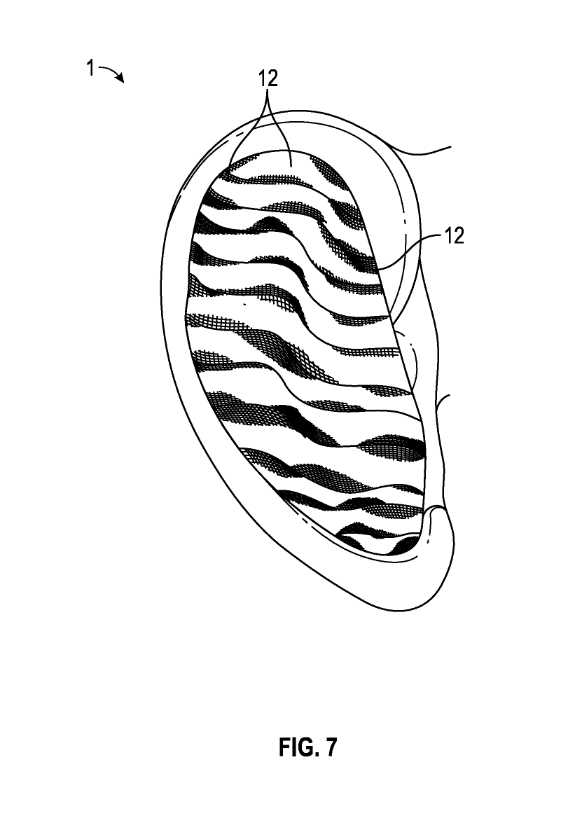

For an exact cast, it is preferred that the plaster splint strips or respectively pieces 12 lie on the skin so that all structures of the auricle 1, such as the helix, crus helicis, scapha, antihelix, fossa triangularis, concha, cymba, cavum, tragus or respectively antitragus and in particular the undercut areas of the aforementioned structures are formed exactly. This is shown in FIG. 7.

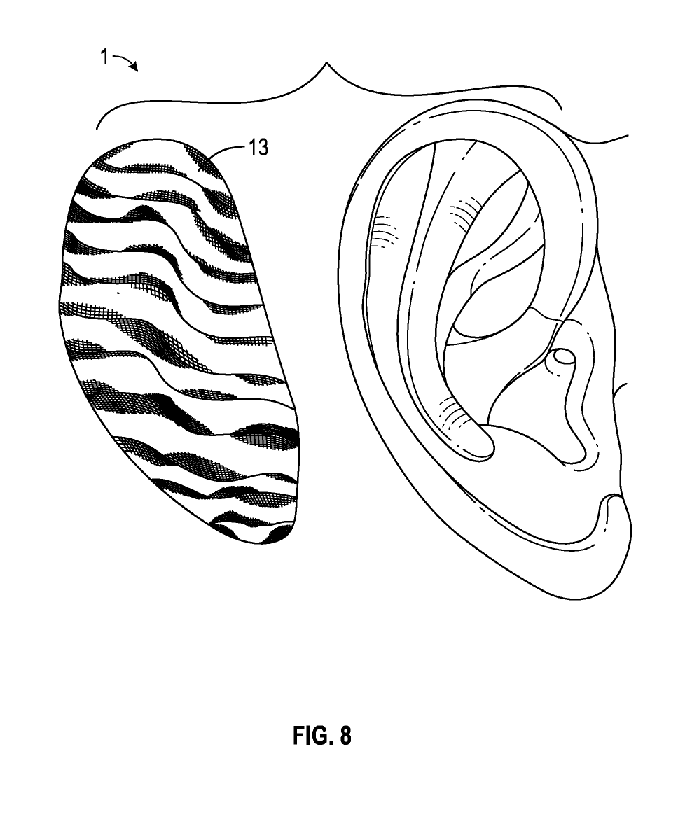

For the stability of such a plaster cast, it is advantageous to arrange at least 3-4 layers of the plaster bandage on the entire surface of the auricle 1. After the hardening, the plaster cast 13 formed in this manner can be removed from the auricle, as shown in FIG. 8.

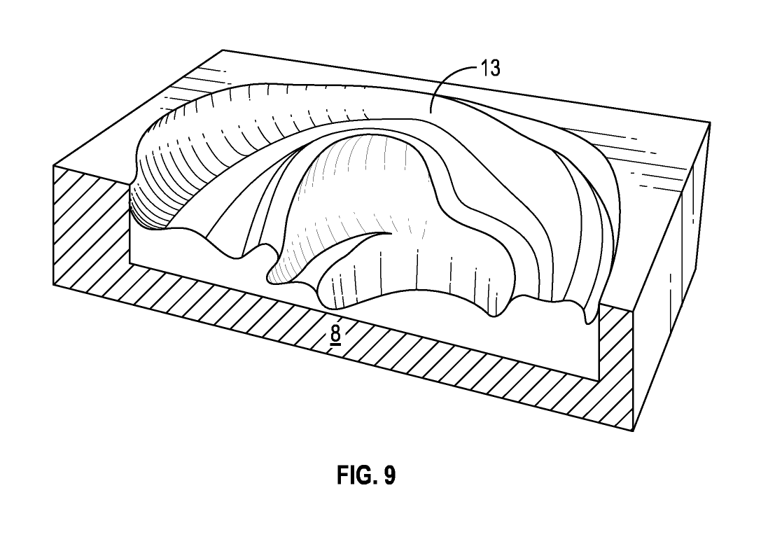

The shaping of the fit film 3 can take place as initially explained with respect to FIGS. 3 and 4, wherein the obtained plaster cast 13 is used to mold the first cast film 9. FIG. 9 shows a perspective partial view of the plaster cast 13 in the deep-draw device 8 previously mentioned with respect to FIGS. 3 and 4.

The invention was explained above using exemplary embodiments. However, the invention is not limited to the above exemplary embodiments. In particular, the explained exemplary embodiments permit numerous changes or additions. In the same manner, it is conceivable to combine individual aspects, characteristics, method steps or the like of the shown exemplary embodiments. For example, it is conceivable that
in the exemplary embodiment of FIGS. 2-4 the fit film 3 is made of ethyl vinyl acetate and the first cast film 9 is made of polyethylene terephthalate copolyester,
in the exemplary embodiment of FIGS. 2-4, instead of the impression of the first cast film 9 on the cast 7 for producing a positive cast, a positive cast is formed on the cast 7 by means of a latex, alginate, polyether and/or silicone material,
in all exemplary embodiments, instead of the impression of the fit film 3 in a thermoforming method, the fit film 3 is formed by means of a 3D printer,
in all exemplary embodiments and in particular in the case of particularly strong undercut areas of the auricle of the user, before the molding of the fit film 3 in an intermediate step, additional liquid material is introduced into the mold, for example in order to strengthen the fit film 3 area-by-area and/or
the introduction of additional material takes place with a commercially available hotmelt gun, wherein the used sticks are made of the same plastic material as the fit or respectively deep-draw film. In the subsequent thermoforming or respectively deep-draw process, this material fuses with the film.

The use of the term “comprising” or respectively “comprises” in the claims and the present description does not exclude the presence of additional features. Also, the use of indefinite articles does not exclude a plurality. The mere listing of individual features in different dependent claims does not indicate that a combination of these features cannot be used according to the invention in an advantageous exemplary embodiment. The use of reference numbers should not be interpreted in a restricting manner.

What is claimed is:

1. A mount for earphones with at least one fit film, wherein the fit film comprises a holding section for the earphone and is adapted for attachment to the auricle of a user.

2. The mount for earphones according to claim 1, wherein the holding section comprises an opening, which is adapted to receive the earphone.

3. The mount for earphones according to claim 1, wherein the fit film is configured to engage in the operating position with the crus helicis, the cymba, the tragus and/or the antitragus of the auricle.

4. The mount for earphones according to claim 1, wherein the fit film is configured so that a substantially closed volume is given in the operating position between earphone and the eardrum of the user.

5. The mount for earphones according to claim 1, wherein the fit film has an even thickness.

6. The mount for earphones according to claim 1, wherein the fit film is produced using an impression of the auricle of the user.

7. A method for producing a mount for earphones, wherein
a cast of the auricle of a user is formed,
at least one fit film for attachment to the auricle of the user is formed in an impression method using the cast and
at least one holding section for the earphone is formed in the fit film to obtain a mount for the earphone.

8. The method according to claim 7, wherein a cast film is molded on the cast of the auricle and the fit film is molded on the cast film.

9. The method according to claim 7, wherein the impression method is a thermoforming method.

10. The method according to claim 8, wherein the elasticity of the cast film differs from the elasticity of the fit film.

11. The method according to claim 7, wherein the at least one holding section is formed by an opening in the fit film.

12. The method according to claim 11, wherein the opening is formed in the fit film by punching.

13. A mount for earphones, provided according to the method according to claim 7.

14. A set of at least two mounts for earphones according to claim 1, wherein a first fit film is configured for attachment to a first auricle of a user and a second fit film is configured for attachment to a second auricle of the user.
